(19) United States
(12) Patent Application Publication
(10) Pub. No.: US 2005/0186993 A1
(43) Pub. Date: Aug. 25, 2005

(54) Communication apparatus for playing sound signals

(76) Inventor: Wen Hsiang Yueh, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/784,244

(22) Filed: Feb. 24, 2004

(51) Int. Cl. H04Q 7/20

(52) U.S. Cl. 455/566

(57) ABSTRACT

A communication apparatus for playing sound signals has a cellular phone and a wireless earphone. The cellular phone communicates with the wireless earphone via Bluetooth signals primarily. The cellular phone has a first sound processing module for encoding, a music playing module for outputting music data and a Bluetooth module. The wireless earphone has a second sound processing module for decoding, an output unit for outputting music and a Bluetooth module. The music data from the music playing module can be encoded into digital data fitting the Bluetooth protocol by using the first sound processing module. Then, the digital data is sent to the wireless earphone. After being received, the digital data is decoded via the second sound processing module and then output by the output unit. Thereby, the cellular phone can use Bluetooth signals to radio the music data to the wireless earphone for playing music.

### FIELD OF THE INVENTION

The present invention is directed to a communication apparatus for playing sound signals, and more particularly, to a communication apparatus constituted by a Bluetooth cellular phone and a wireless earphone.

### BACKGROUND OF THE INVENTION

Conventionally, Bluetooth technique is a low-cost, low-power and short-distance wireless communication technique, which can be extensively applied to any kind of personal mobile communication apparatus. By using the wireless transmitting function of the Bluetooth technique, one can develop a Bluetooth earphone, a portable watch equipped with a cellular phone or a communication device capable of being worn on a finger. These products can only use a built-in Bluetooth chip to perform wireless transmission, access Internet or send/receive e-mails. This is quite user-friendly.

There are various wireless earphones equipped with a Bluetooth module in the market. These products are usually used with Bluetooth cellular phones. Reference is made to FIG. 1, which is a block diagram of a conventional communication apparatus comprising a cellular phone and a wireless earphone. Therein, the Bluetooth modules 73, 81 of the cellular phone 70 and the wireless earphone 80 can communicate with each other in a wireless full-duplex manner. Hence, the cellular phone 70 can receives sound signals via the mobile communication control module 71 and then send the sound signals to the wireless earphone 80 via the Bluetooth module 73. After reception by the Bluetooth module 81 of the wireless earphone 80, the sound signals can be heard by a user via the earphone module 83 disposed inside the wireless earphone 80 (a speaker is used to output the sound signals). Then, the user can also use the earphone module 83 to reply (a microphone is used to receive user's voice).

However, based on the requirements of the market, recent cellular phones are usually capable of playing multimedia files. As shown in FIG. 1, the cellular phone 70 has a music playing module 75 built inside. Hence, a user can use the cellular phone 70 to hear music via a wired earphone or a speaker disposed in the cellular phone 70.

From the user's aspect, a friendlier interface of the cellular phone 70 for outputting sounds is desired. Since the wired earphone can easily trip a user listening to music, the wired earphone is very inconvenient. Further, if a speaker is used to output the music, the user cannot enjoy high-quality music because of the environmental interferences.

Consequently, using a wireless earphone to listen to music is a better solution. However, the bandwidth employed in the present Bluetooth technique is about 1 Mbps, while the necessary bandwidth for transmitting sound signals with music format is at least 30 Mbps. Hence, direct combination of the conventional Bluetooth cellular phone with the wireless earphone cannot be used to transmit sound signals.

Accordingly, as discussed above, the prior art still has some drawbacks that could be improved. The present invention aims to resolve the drawbacks in the prior art.

### SUMMARY OF THE INVENTION

An objective of the present invention is to provide a communication apparatus for playing sound signals that can transmit played music from a cellular phone to a wireless earphone data via employing signals fitting the Bluetooth protocol.

Another objective of the present invention is to provide a communication apparatus for playing sound signals that can output stereo music. For reaching the objective above, the present invention provides a communication apparatus for playing sound signals, comprising a cellular phone and a wireless earphone. The cellular phone comprises a music playing module used to output music data, a first sound processing module used to encode the music data and output digital data, a first Bluetooth module used to transmit the digital data and a mobile communication control module used to transmit/receive radio signals and control the music playing module. The wireless earphone comprises a second Bluetooth module used to receive the digital data from the first Bluetooth module, a second sound processing module used to decode the digital data, and an output unit used to output the digital data decoded by the second sound processing module. For reaching the objective above, the present invention also provides a communication method for playing sound signals. The method providing a cellular phone equipped with a first Bluetooth module, encoding music data played by the cellular phone according to a Bluetooth protocol to form digital data and radioing the digital data via the first Bluetooth module of the cellular phone, receiving the digital data via a wireless earphone equipped with a second Bluetooth module, and decoding the digital data and outputting the decoded digital data via the wireless earphone.

For reaching the objective above, the present invention further provides a cellular phone for transmitting sound signals. The cellular phone comprises a music playing module used to output music data, a sound processing module used to encode the music data and output digital data, a Bluetooth module used to transmit the digital data, and a mobile communication control module used to transmit/receive radio signals and control the music playing module.

For reaching the objective above, the present invention additionally provides a wireless earphone for receiving sound signals. The wireless earphone comprises a Bluetooth module used to receive digital data, a sound processing module used to decode the digital data, an output unit used to output the digital data decoded by the sound processing module, and a microprocessor used to determine a format of the digital data and then send the digital data to the sound processing module directly or to the output unit after processing the digital data according to a determined result.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a block diagram of a conventional communication apparatus constituted by a cellular phone and a wireless earphone;

FIG. 2 is a block diagram of a communication apparatus for playing sound signals in accordance with the present invention;

FIG. 3 is a block diagram of an music playing module in accordance with the present invention; and

FIG. 4 is a flowchart of a communication method for playing sound signals in accordance with the present invention.

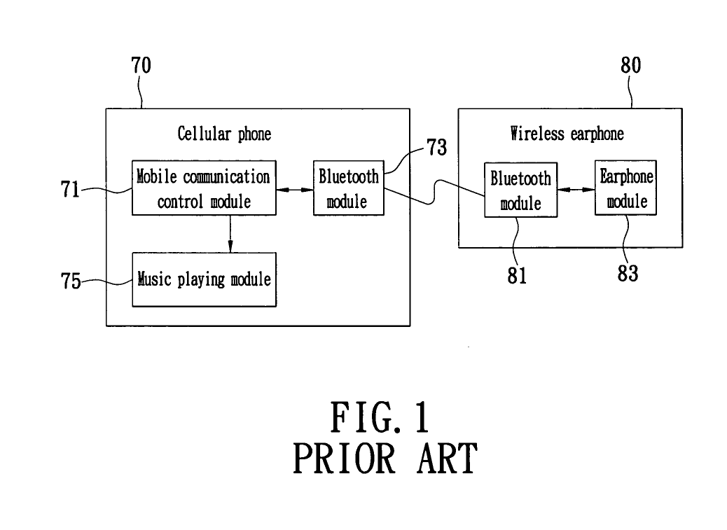

### DETAILED DESCRIPTION

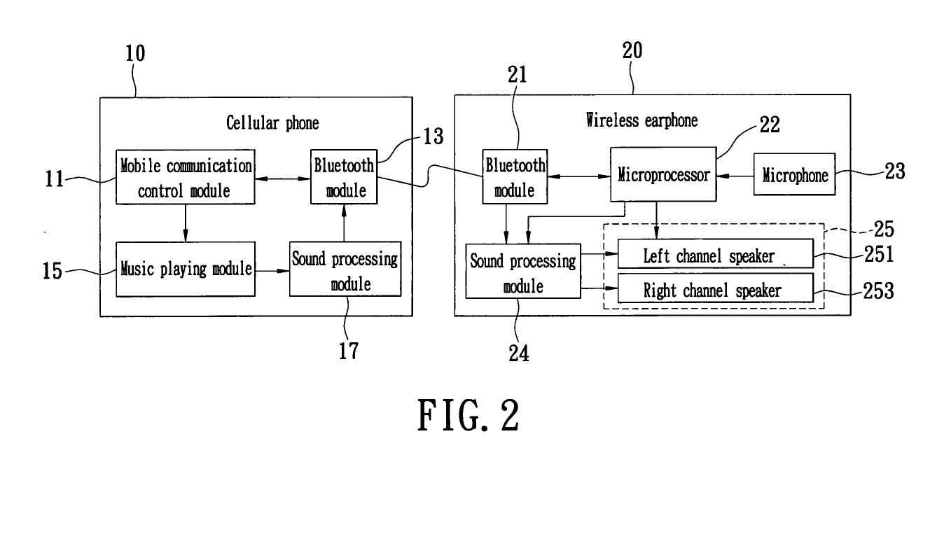

Reference is made to FIG. 2, which is a block diagram of a communication apparatus for playing sound signals in accordance with the present invention. The communication apparatus of the present invention includes a cellular phone 10 and a wireless earphone 20.

Therein, the cellular phone 10 includes a mobile communication control module 11, a Bluetooth module 13, a music playing module 15 and a sound processing module 17. The mobile communication control module 11 is used to transmit/receive radio signals and to control the music playing module 15. The Bluetooth module 13 is used to transmit received sound signals to the wireless earphone 20 in a wireless manner. The music playing module 15 is able to output played music data to the sound processing module 17, which will encode the data to fit the Bluetooth protocol. In this embodiment, the Bluetooth module 13 can also be used to transmit the encoded data from the sound processing module 17 to the wireless earphone 20 in a wireless manner.

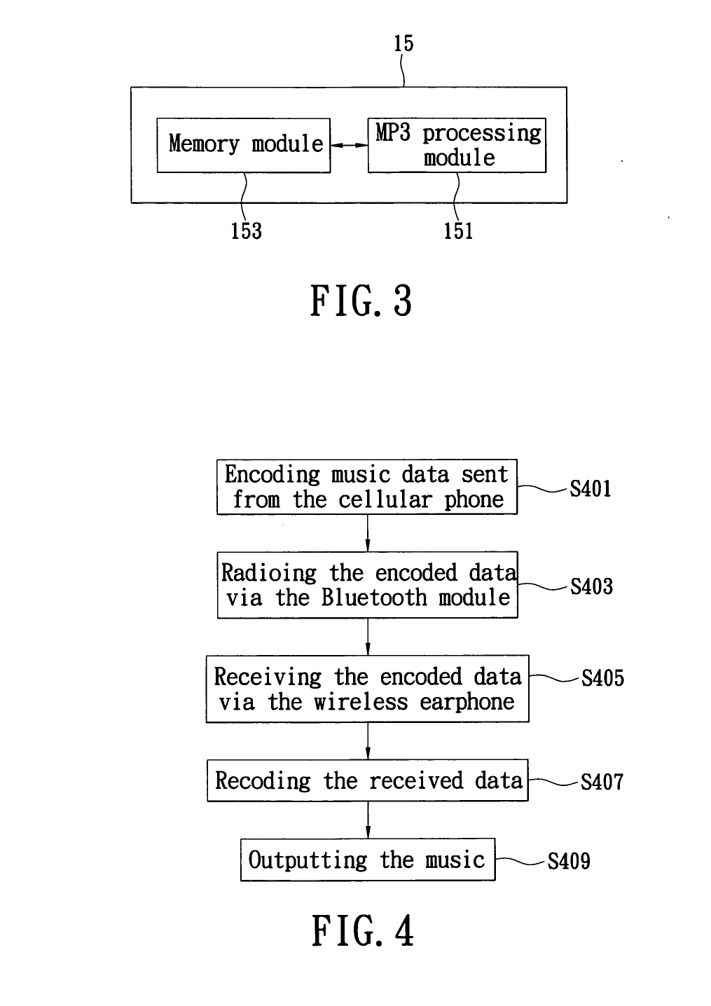

The music playing module 15 can be a radio circuit or, as shown in FIG. 3, comprise a MP3 processing module 151 and a memory module 153. The memory module 153 can be used to store MP3 music files while the MP3 processing module 151 can be used to play them.

On the other hand, the wireless earphone 20 includes a Bluetooth module 21, a microprocessor 22, a microphone 23, a sound processing module 24 and an output unit 25. The Bluetooth module 21 can receive the sound signals or encoded data from the Bluetooth module 13 of the cellular phone 10. The microprocessor 22 can determine if the received data format belongs to the sound signals or encoded data. If the sound signals are received, after processing by the microprocessor 22, the sound signals will be sent to the left channel speaker 251 of the output unit 25. At this time, a user can also speak via the microphone 23 for response, and the voice from the user will be processed by the microprocessor 22 and then sent back to the cellular phone 10 via the Bluetooth module 21. If the encoded data are received, the microprocessor 22 will send the data to the sound processing module 24 for decoding and recovering the original music data and then send the recovered data to the left and right channel speakers 251, 253 of the output unit 25 for outputting stereo music.

In the embodiment, the used output unit 25 includes the left and right channel speakers 251, 253, which correspond to the two sound channels of the music data with stereo sound. Further, for outputting the sound signals with a single sound channel from the cellular phone 10, only one of the speakers of the output unit 25 is needed. Besides, one of the left and right channel speakers 251, 253 can be independently disposed in another housing via a detachable extended line. Hence, when the user only uses the earphone 20 to hear the sound signals from the cellular phone 10, he can detach the independently disposed speaker to reduce the burden.

Reference is made to FIG. 4, which is a flowchart of a communication method for playing sound signals in accordance with the present invention. In order to send the played music data from the cellular phone 10 to the wireless earphone 10 in a wireless manner, the music data from the cellular phone 10 is encoded (S401). The music data is output from the music playing module 15 and encoded by the sound processing module 17. The encoded data is radioed via the Bluetooth module 13 of the cellular phone 10 (S403). The wireless earphone 200 can then receive the data via the Bluetooth module 21 (S405). The sound processing module 24 of the earphone 20 will decode the data to recover the original music data (S407). Finally, the earphone 20 will output a stereo music via the left and right channel speakers 251, 253 of the output unit 25 (S409).

Consequently, the communication apparatus for playing sound signals of the present invention can enable the cellular phone 10 to transmit the sound signals via Bluetooth module 13. The sound signals are encoded by the sound processing module 17 to fit the Bluetooth protocol before transmission. When the encoded data are received by the wireless phone 20, the data are first decoded by the sound processing module 24 and then sent to the output unit 25. The output unit 25 employs the left and right channel speakers 251, 253 to allow the wireless earphone 20 to provide music in stereo.

Therefore, the communication apparatus for playing sound signals of the present invention has the following features:
(1) Music data can be played via a cellular phone and received by a wireless earphone; and
(2) The wireless earphone employs two sound channels to provide a stereo music.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are embraced within the scope of the invention as defined in the appended claims.

1. A communication apparatus for playing sound signals, comprising a cellular phone and a wireless earphone, the cellular phone comprising:
a music playing module used to output music data;
a first sound processing module used to encode the music data and output digital data;
a first Bluetooth module used to transmit the digital data; and
a mobile communication control module used to transmit/receive radio signals and control the music playing module; and the wireless earphone comprising:
a second Bluetooth module used to receive the digital data from the first Bluetooth module;
a second sound processing module used to decode the digital data; and
an output unit used to output digital data decoded by the second sound processing module.

2. The apparatus as claimed in the claim 1, wherein the music playing module is a radio circuit.

3. The apparatus as claimed in the claim 1, wherein the music playing module comprises:
a memory used to store a music file; and
an MP3 processing module used to play the music file.

4. The apparatus as claimed in the claim 1, wherein the output unit comprises a left channel speaker and a right channel speaker.

5. The apparatus as claimed in the claim 4, wherein the left or the right channel speaker is independently disposed in another housing via an extended line.

6. The apparatus as claimed in the claim 5, wherein the extended line is detachable.

7. A communication method for playing sound signals, comprising:
providing a cellular phone equipped with a first Bluetooth module;
encoding music data played by the cellular phone according to a Bluetooth protocol to form digital data and radioing the digital data via the first Bluetooth module of the cellular phone;
receiving the digital data via a wireless earphone equipped with a second Bluetooth module and decoding the digital data; and
outputting the decoded digital data via the wireless earphone.

8. The method as claimed in the claim 7, wherein the music data are in an MP3 format.

9. The method as claimed in the claim 7, wherein the music data are signals received by a radio.

10. The method as claimed in the claim 7, wherein the wireless earphone outputs the decoded digital data via two sound channels.

11. A cellular phone for transmitting sound signals, comprising:
a music playing module used to output music data;
a sound processing module used to encode the music data and output digital data;
a Bluetooth module used to transmit the digital data; and
a mobile communication control module used to transmit/receive radio signals and control the music playing module.

12. The cellular phone as claimed in the claim 11, wherein the music playing module is a radio circuit.

13. The cellular phone as claimed in the claim 11, wherein the music playing module comprises:
a memory used to store a music file; and
an MP3 processing module used to play the music file.

14. A wireless earphone for receiving sound signals, comprising:
a Bluetooth module used to receive digital data;
a sound processing module used to decode the digital data;
an output unit used to output digital data decoded by the sound processing module; and
a microprocessor used to determine a format of the digital data and then send the digital data to the sound processing module directly or to the output unit after processing the digital data according to a determined result.

15. The wireless earphone as claimed in the claim 14, wherein the output unit comprises a left channel speaker and a right channel speaker.

16. The wireless earphone as claimed in the claim 15, wherein the left or right channel speaker is independently disposed in another housing via an extended line.

17. The wireless earphone as claimed in the claim 16, wherein the extended line is detachable.

18. The wireless earphone as claimed in the claim 14, further comprising a microphone, the microprocessor outputting voice signals received from the microphone via the Bluetooth module.
